(19) United States
(12) Patent Application Publication
(10) Pub. No.: US 2023/0075054 A1
(43) Pub. Date: Mar. 9, 2023

(54) UTILITY VEHICLE HAVING FUEL CELL DEVICE

(71) Applicant: MAN Truck & Bus SE, München (DE)

(72) Inventors: Roman Haas, MÜNCHEN (DE); Norbert Burger, MÜNCHEN (DE); Jochen Butscher, MÜNCHEN (DE)

(73) Assignee: MAN Truck & Bus SE, München (DE)

(21) Appl. No.: 17/794,231

(22) PCT Filed: Jan. 19, 2021
(86) PCT No.: PCT/EP2021/050985

§ 371 Date: Jul. 20, 2022

(30) Foreign Application Priority Data
Jan. 20, 2020 (DE) 10 2020 000 314.1

(51) Int. Cl. B60L 58/40; B60L 1/00; B60K 1/04; B60L 50/62; B60L 50/71; B60L 50/75; B60L 58/13; B60L 58/27; B60L 7/10

(52) U.S. Cl. CPC B60L 58/40; B60L 1/003; B60K 1/04; B60L 1/006; B60L 50/62; B60L 50/71; B60L 50/75; B60L 58/13; B60L 58/27; B60L 7/10; B60L 2200/28; B60L 2200/40; B60L 2240/34; B60L 2240/36; B60L 2240/545; B60L 2240/62; B60L 2240/662; H01M 2250/20

(57) ABSTRACT

The invention relates to a utility vehicle (IO), preferably a truck, comprising a structure (22) or trailer (46) having a consumer (20) and a fuel cell device (12). The fuel cell device (12) is designed to be connectable as a range extender of the utility vehicle (IO) and to supply the consumer (20) with electrical power and/or waste heat.

The present disclosure relates to a utility vehicle, preferably a truck, having a fuel cell device.

DE 10 2016 224 484 A1 discloses an electric vehicle with a traction battery and a range extender. The range extender is designed in such a way that waste heat from the range extender contributes to heating the vehicle interior and/or the traction battery. The range extender can comprise fuel cells.

DE 10 2015 011 274 A1 describes a fuel cell vehicle in which the fuel cell stack is used as a range extender, i.e. to extend the range of the vehicle that can be achieved with the battery or traction battery in electric driving mode. It is described that the waste heat of a fuel cell can be used in winter to heat the interior of the vehicle. In addition, the heat is available to control the temperature of the traction battery in the vehicle.

The known prior art is primarily dedicated to the integration of a fuel cell in a passenger vehicle. The integration in a utility vehicle, such as a truck with a body or trailer, on the other hand, can lead to alternative or additional requirements.

Battery-powered utility vehicles use only electrical energy storage devices to store the necessary motive energy. As a result, however, they are affected by the long charging times during operation, or are forced to endure longer periods of downtime. If the utility vehicle is now extended to include a body or trailer that requires electrical energy, the energy available for propulsion is significantly reduced. In conventional vehicles, the additional energy supply can be realized by a mechanical power take-off.

The present disclosure addresses the problem of creating an alternative and/or improved technology for a utility vehicle having a fuel cell device.

The problem is solved by the features of independent claim 1. Advantageous developments are specified in the dependent claims and the description.

One aspect of the present disclosure relates to a (for example electric battery-powered or hybrid) utility vehicle, preferably a truck. The utility vehicle comprises a (for example detachable or exchangeable) body or a trailer (for example semi-trailer) with (at least) one (for example electrical and/or thermal) consumer. The utility vehicle has a fuel cell device which is designed to be connectable as a range extender of the utility vehicle and/or to supply the consumer with electrical energy and/or waste heat (for example by demand-led connection or continuous operation).

Preferably, the fuel cell device can thus be used both as a range extender and as a kind of multifunctional power take-off of the utility vehicle, with which a consumer of the body or trailer can be supplied with heat and/or electrical energy. This makes it possible, for example, to dispense with a mechanical power take-off on the drivetrain of the utility vehicle. It is also possible to dispense with a separate energy supply unit (for example diesel generator) on the body or trailer. It is also not necessary to discharge the traction batteries of the utility vehicle and thus impair an electric range of the utility vehicle.

In one exemplary embodiment, the fuel cell device is designed to be operated when the utility vehicle is parked (for example separately or independently). Even during, for example, longer periods of downtime, for example due to legally prescribed rest periods for the driver, the consumer of the body or trailer can be supplied with waste heat and/or electrical energy. In this case, again, the traction batteries are not discharged and thus an electric range of the utility vehicle is not impaired. It is possible that the operation of the consumer is necessary when the utility vehicle is parked or is even only actually possible at all when the utility vehicle is parked.

In a further exemplary embodiment, the fuel cell device is designed to charge a traction battery of the utility vehicle with electrical energy and/or to control the temperature of the traction battery with waste heat. The temperature control can eliminate the need for separate high-voltage heaters for the traction battery, thus saving costs, weight and installation space. The traction battery of the utility vehicle can be charged with electrical energy to increase an electric range of the utility vehicle.

In a further exemplary embodiment, the fuel cell device is designed to supply a cab heater and/or at least one auxiliary unit (for example pump, compressor, motor, actuator) of the utility vehicle with waste heat and/or electrical energy.

In one embodiment, the fuel cell device is designed to control the temperature of the traction battery with waste heat, to supply the cab heater with waste heat, to supply the consumer with waste heat and/or to supply the auxiliary unit with waste heat, when the utility vehicle is parked.

At the same time, the traction battery can be charged with electrical energy, the consumer can be supplied with electrical energy, the cab heater can be supplied with electrical energy and/or the auxiliary unit can be supplied with electrical energy. For example, when parked in winter, the traction battery can be charged and/or the consumer can be supplied with electrical energy and at the same time the cab can be heated with the waste heat.

In a further embodiment, the fuel cell device is designed to control the temperature of the traction battery with waste heat, to supply the cab heater with waste heat, to supply the consumer with waste heat and/or to supply the auxiliary unit with waste heat while the utility vehicle is being driven and, at the same time, to charge the traction battery with electrical energy, to supply the consumer with electrical energy, to supply the cab heater with electrical energy and/or to supply the auxiliary unit with electrical energy. The fuel cell device can thus also be used advantageously while the utility vehicle is being driven.

In one variant, the utility vehicle has a control unit which is designed to control, preferably automatically, an activation, a deactivation and/or an operation of the fuel cell device (for example for supplying electricity and/or heat to the consumer, to the traction battery, to the cab heater and/or to the at least one auxiliary unit). The control can be based on a planned route of the utility vehicle, a planned (for example legally prescribed) driving time, rest time and/or break time of a driver of the utility vehicle, preferably provided by a (for example digital) tachograph, a current and/or planned loading of the utility vehicle, preferably of the body or trailer, and/or a current and/or predicted climate (for example ambient temperature), preferably over a planned route of the utility vehicle. In this way, an intelligent operation of the fuel cell device can preferably be implemented.

Preferably, the term “control unit” can refer to an electronic unit (for example with microprocessor(s) and data memory) and/or mechanical controller, which, depending on the design, can perform open-loop and/or closed-loop control tasks. Even if the term “open-loop control” is used herein, it can thus expediently include “closed-loop control” as it were, or “control with feedback”.

In one variant, the utility vehicle further has a body/trailer interface which can be supplied with electrical energy and/or waste heat from the fuel cell device and to which the consumer is connected. The body/trailer interface can be provided by the utility vehicle manufacturer specifically for the body manufacturers or trailer manufacturers, who can use the body/trailer interface as a power take-off to supply the consumer of the body or trailer.

In a development, the body/trailer interface is a standardized interface to which a variety of different bodies or trailers for the utility vehicle can be connected, preferably detachably.

In one exemplary embodiment, the consumer is detachably connected to the body/trailer interface, preferably plugged in and/or screwed on.

In another exemplary embodiment, the body/trailer interface is arranged in a, preferably rear, region (for example rear wall) of a cab of the utility vehicle. This can thus facilitate connection to the body or trailer, for example.

In another exemplary embodiment, the body/trailer interface comprises an electrical interface for supplying electrical energy to the consumer.

In a further exemplary embodiment, the body/trailer interface comprises a fluid interface for supplying waste heat to the consumer, wherein the fluid interface is preferably fluidically connected and/or thermally coupled to a cooling system of the fuel cell device.

In one embodiment, the utility vehicle further comprises a ladder frame, wherein the fuel cell device is arranged within the ladder frame, preferably directly below a cab of the utility vehicle. Preferably, this results in a protected arrangement of the fuel cell device between the two longitudinal members of the ladder frame.

In a development, the fuel cell device has a fuel cell stack and a fuel tank, wherein the fuel tank is arranged inside the ladder frame and/or behind the fuel cell stack with respect to a forward direction of travel of the utility vehicle. Preferably, this also results in a protected arrangement of the fuel tank between the two longitudinal members of the ladder frame.

In one variant, the utility vehicle has a plurality of traction batteries. Preferably, the fuel cell device can have substantially the same dimensions and/or connection points as each of the plurality of traction batteries, so that the fuel cell device and the plurality of traction batteries can be arranged interchangeably. Depending on the customer's requirements or the intended use of the utility vehicle, the number and/or arrangement of the fuel cell device or devices and of the traction battery or batteries can thus be easily adapted.

In a further variant, the fuel cell device is embodied as a pre-assembled and/or independently testable module, which has a cooling fluid interface, an electrical interface (for example high-voltage connection) and/or a control interface. The functionality of the fuel cell device can thus be tested via the interfaces even before assembly on the utility vehicle, and the assembly process can be carried out quickly and easily.

In one exemplary embodiment, the fuel cell device is embodied as a reversible fuel cell device for producing hydrogen during recuperation when braking the utility vehicle, preferably during a connectable continuous braking mode of the utility vehicle. This enables, for example, the elimination of additional cooled braking resistors during continuous braking operation.

In one exemplary embodiment, the fuel cell device comprises a polymer electrolyte fuel cell (PEMFC), a direct methanol fuel cell (DMFC) and/or a reforming methanol fuel cell (RMFC).

In one embodiment, the body is supported on a frame (for example ladder frame) of the utility vehicle and/or is arranged behind a cab of the utility vehicle.

In another embodiment, the body is a tank body (for example milk tank body, fuel tank body, concrete mixer body), an emergency vehicle body (for example fire department body, military body, police body, technical aid body), a cleaning body (for example flushing vehicle body, suction vehicle body), a loading body (for example rear loading body, side loading body), a cooling body or a heating body.

In a further embodiment, the trailer comprises a tank, a loading area, a loading space, a cooling unit, a heating unit and/or a pump.

In another embodiment, the trailer is a semi-trailer.

In a further embodiment, the utility vehicle is a trailer truck or an articulated truck.

In another embodiment, the consumer comprises an electrically driven machine (for example electric motor, pump, compressor, working cylinder, actuator) and/or a heat exchanger.

In one exemplary embodiment, the consumer comprises an electrical energy storage device. Preferably, the electrical energy storage device can be charged by the fuel cell device, preferably when the trailer or semi-trailer is coupled to the rest of the utility vehicle. Advantageously, this enables electrical energy to be available in the trailer or body when uncoupled from the rest of the utility vehicle and an electrically driven machine of the trailer or body can be supplied with electrical energy from the electrical energy storage device of the trailer or body. For example, an uncoupled refrigeration body or refrigeration trailer can also maintain an electrically driven cooling system in the uncoupled state.

In another exemplary embodiment, the trailer has an electrically drivable axle (for example rigid or steerable) that is operable with electrical energy from the electrical energy storage device of the consumer. Preferably, the electrically drivable axle is operable with electrical energy from the electrical energy storage device when the trailer is uncoupled from a tractor of the utility vehicle. It is also possible that the electrically drivable axle charges the electrical energy storage device by recuperation during driving operation. Advantageously, the trailer can thus be driven independently of the tractor, for example in a depot, for movement, for example completely autonomously or coupled to a driverless transport vehicle for steering.

In a further exemplary embodiment, the consumer further comprises a heat exchanger for controlling the temperature of the electrical energy storage device.

In a further exemplary embodiment, the consumer further comprises an electrically driven machine (for example electric motor, pump, compressor, working cylinder, actuator), which is operable with electrical energy from the electrical energy storage device of the consumer, preferably in the uncoupled state of the trailer or body from the utility vehicle.

In another exemplary embodiment, the electrical energy storage device can be charged externally (from the utility vehicle) by means of an electrical charging connection, wherein the electrical charging connection preferably is arranged on the utility vehicle separately from the trailer or body (for example on a tractor unit, a cab and/or a vehicle frame of the utility vehicle). Advantageously, an extra charging connection with a corresponding on-board charger on the trailer or semi-trailer can thus be spared. Additionally or alternatively, it is also possible for the trailer or body to have its own electrical charging connection (for example with on-board charger) for external charging of the electrical energy storage device.

The preferred embodiments and features of the present disclosure described above can be combined with each other as desired. Further details and advantages of the present disclosure are described below with reference to the accompanying drawings, in which:

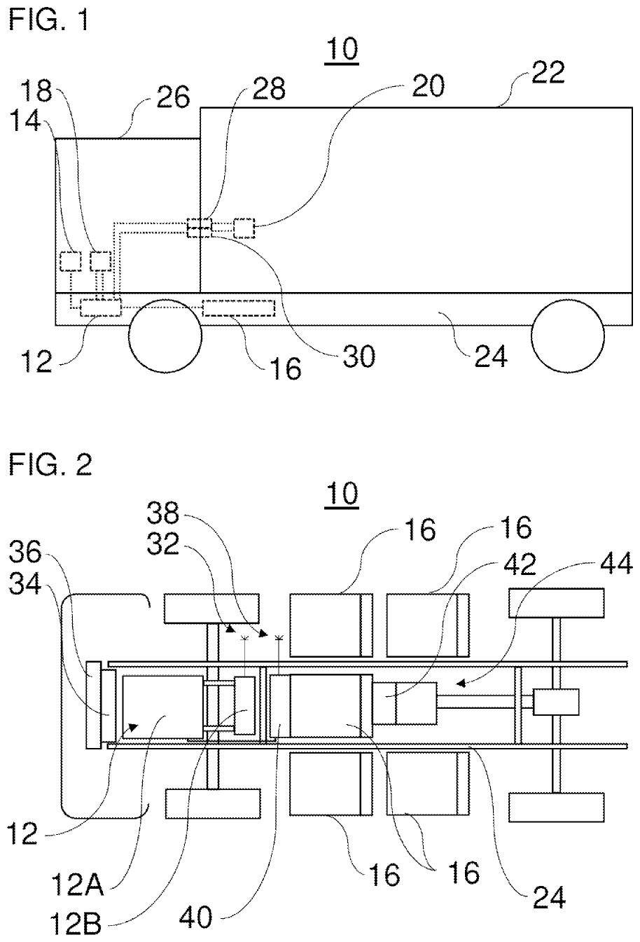

FIG. 1 shows a schematic side view of an exemplary utility vehicle with a fuel cell device and a body;

FIG. 2 shows a schematic view of an exemplary frame of a utility vehicle with a fuel cell device; and

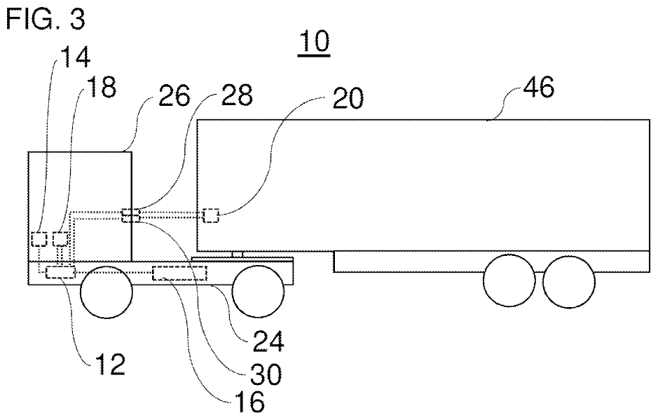

FIG. 3 shows a schematic side view of an exemplary utility vehicle with a fuel cell device and a trailer.

The embodiments shown in the figures correspond at least in part, so that similar or identical parts are provided with the same reference signs and reference is also made to the description of the other embodiments or figures for their explanation in order to avoid repetition.

FIG. 1 shows a utility vehicle 10. The utility vehicle 10 is preferably embodied as a truck.

The utility vehicle 10 has a fuel cell device 12 and a control unit 14.

The fuel cell device 12 is designed to generate electrical energy from a fuel, for example hydrogen or methanol. During operation, the fuel cell device 12 also produces waste heat.

The fuel cell device 12 can, for example, comprise a polymer electrolyte fuel cell (PEMFC), a direct methanol fuel cell (DMFC) and/or a reforming methanol fuel cell (RMFC). Thus, for example, operation using reformed methanol can also be possible, so that operation with conventional biofuels is possible. This can ensure worldwide fuel availability.

On the one hand, the fuel cell device 12 can provide electrical energy. On the other hand, the fuel cell device 12 can provide waste heat that is generated during the generation of electrical energy and that can also be used. To use the waste heat of the fuel cell device 12, a fluid connection and/or a heat coupling to the cooling circuit of the fuel cell device 12 can be provided, for example.

The fuel cell device 12 can be used in a variety of ways, as explained below by means of examples that can be combined with one another or—if desired—can each also be applied individually.

The fuel cell device 12 can be used as a range extender of the utility vehicle 10. The fuel cell device 12 can be connected as a range extender if desired. The connection can be controlled by the control unit 14. The fuel cell device 12 can, for example, charge at least one traction battery 16 of the utility vehicle 10 with electrical energy. In this way, an electric range of the utility vehicle 10 can be increased.

The fuel cell device 12 can be used to control the temperature of the traction battery 16. The traction battery 16 is supplied with waste heat from the fuel cell device 12. For example, a temperature control circuit of the traction battery 16 can be coupled with a cooling circuit of the fuel cell device 12, for example by means of a heat exchanger.

The fuel cell device 12 can supply at least one auxiliary unit 18 of the utility vehicle 10 with electrical energy and/or waste heat. The at least one auxiliary unit 18 can, for example, comprise a cab heater of the utility vehicle 10, and said cab heater can be supplied with electrical energy and/or with waste heat. The cab heater can use the waste heat from the fuel cell device 12 to heat a cab 26 of the utility vehicle 10. Alternatively, or additionally, the cab heater can comprise an electrical heating unit, which can be supplied with electrical energy from the fuel cell device 12 to heat the cab 26. However, the auxiliary unit 18 can also comprise other devices such as a pump, a motor, a compressor, an actuator, a heat exchanger and/or a socket, etc.

The fuel cell device 12 can supply at least one consumer 20 of a body 22 of the utility vehicle 10 with electrical energy and/or waste heat. Preferably, the fuel cell device 12 can provide the necessary energy for operating the body 22 or the consumer 20 by hydrolysis. The electric range of the utility vehicle 10 is thus not affected. The fuel cell device 12 can also be used as a thermal power take-off. The waste heat from the fuel cell device 12 can, for example, supply a heating system of the body 22 with heat.

The body 22 is supported on a ladder frame 24 of the utility vehicle 10. The body 22 is arranged behind the cab 26 of the utility vehicle 10 with respect to a forward direction of travel of the utility vehicle 10. The body 22 can be manufactured by a so-called body builder or body manufacturer. Typically, after the utility vehicle 10 has been manufactured by the utility vehicle manufacturer, the body 22 is mounted on the ladder frame 24 by the specialized body manufacturer. For example, the body 22 can be a tank body (for example, milk tank body, fuel tank body, concrete mixer body), an emergency vehicle body (for example, fire department body, military body, police body, technical aid body), a cleaning body (for example flushing vehicle body, suction vehicle body), a loading body (for example rear loading body, side loading body), a cooling body or a heating body. The body 22 can have at least one electrically driven machine (for example electric motor, pump, compressor, working cylinder, actuator) and/or a heat exchanger as the at least one consumer 20.

The consumer 20 of the body 22 can be connected to a body or bodies/trailer interface 28, 30 of the utility vehicle 10 for supplying waste heat and/or electrical energy.

The interface 28, 30 can be standardized to allow the connection of a variety of different set-ups. The interface 28, 30 can comprise an electrical interface 28 and/or a fluid interface 30. Electrical energy can be transmitted from the fuel cell device 12 to the consumer 20 via the electrical interface 28. A fluid heated directly or indirectly by the fuel cell device 12 can be transmitted to the consumer 20 via the fluid interface 30. The fluid can, for example, originate directly from a cooling circuit of the fuel cell device 12 or can be coupled to the cooling circuit of the fuel cell device 12 via a heat exchanger. Preferably, the consumer 20 can be detachably connected to the interface 28, 30, for example by means of a screw connection and/or a plug-in connection. For example, the electrical interface 28 can be a plug-socket interface. The fluid interface 30 can be, for example, a pipe flange interface.

The interface 28, 30 can preferably be located in the region of the cab 26 of the utility vehicle 10. For example, the interface 28, 30 can be arranged in a rear region of the cab 26, for example on a rear wall of the cab 26.

It is possible for the fuel cell device 12 to be operated when the utility vehicle 10 is parked, wherein the propulsion device (for example electric drive unit(s), internal combustion engine, etc.) of the utility vehicle 10 is deactivated. Thus, when the utility vehicle 10 is parked, the consumer 20, the auxiliary unit 18 and/or the traction battery 16 can be supplied with electrical energy and/or waste heat from the fuel cell device 12, as required.

For example, the traction battery 16 can be charged with electrical energy from the fuel cell device 12. In this way, the electric range of the utility vehicle 10 can be increased without having to charge the traction battery 16 externally. The waste heat generated by the fuel cell device 12 can be used to supply the auxiliary unit 18, the consumer 20 and/or the traction battery 16.

In another example, the consumer 20 can be supplied with electrical energy. The waste heat from the fuel cell device 12 can in turn be used to supply the traction battery 16, the auxiliary unit 18 and/or the consumer 20. The fuel cell device 12 can be operated accordingly by the control unit 14 depending on the current requirement.

It is also possible for the fuel cell device 12 to be operated while the utility vehicle 10 is being driven, for example as described above.

The operation of the fuel cell device 12 can be controlled accordingly by the control unit 14. For example, the control unit 14 can activate and deactivate the fuel cell device 12 as desired.

For example, the control unit 14 can automatically control a connection and disconnection of the fuel cell device 12 in order to generate electrical energy and waste heat as desired. This can increase the overall efficiency of the utility vehicle 10. The connection can be dependent on different parameters that can be combined with each other, which can also each be applied only individually if desired.

The connection can be dependent on a planned route of the utility vehicle 10. Information about the upcoming route can be provided, for example, by a navigation system of the utility vehicle. The information can include charging station locations, refueling station locations, route lengths, gradients, inclines, traffic data and/or traffic rules, etc. If the electric range of the traction battery 16 is not sufficient or is no longer sufficient for the planned route, or if insufficient charging options are available, the fuel cell device 12 can be activated in the background as a range extender. If, on the other hand, the electric range is sufficient and the utility vehicle 10 can be charged afterwards, for example, it is not necessary to connect the fuel cell device as a range extender.

The connection can be dependent on a planned (for example legally prescribed) driving time, rest time and/or break time of the driver of the utility vehicle 10. Information regarding these times can be provided by a digital tachograph (journey recorder) of the utility vehicle 10. Based on the information, the control unit 14 can estimate when the utility vehicle 10 will make a stop and the minimum duration of this stop. During the stop, it can be necessary, for example, to supply the consumer 20 or the auxiliary unit 18 with waste heat and/or electrical energy from the fuel cell device 12 without impairing the electrical range of the utility vehicle, i.e. without discharging the traction battery 16.

It is also possible, for example, for the control unit 14 to determine that the activation of the fuel cell device 12, for example for range extension, only takes place when the utility vehicle 10 is parked, and waste heat from the fuel cell device 12 can be used, for example, to heat the cab 26 and/or to control the temperature of the traction battery or batteries 16, for example in winter. For example, an outside thermometer of the utility vehicle 10 or a received temperature forecast can be used to detect that a heating of the cab 26 will be necessary when the vehicle is stationary. The control unit 14 can recognize the upcoming parking, for example, from information regarding the current or planned driving time, rest time and/or break time and/or depending on the planned route (for example planned intermediate stops for loading, unloading, etc.).

The connection can be dependent on a current and/or planned loading of the utility vehicle 10, preferably of the body 22 (for example up to 40 t or empty). Here, for example, a changing energy consumption for driving the utility vehicle 10 and/or a changing energy consumption of the consumer 20 (for example only cooling necessary when loaded) can be taken into account or predicted. Information regarding the planned loading of the utility vehicle 10 can be entered, for example, via a user interface of the utility vehicle 10 and/or can be received by means of a communication interface of the utility vehicle 10, for example, from a control center. Information regarding a current load of the utility vehicle 10 can be detected, for example, by load sensors, estimated by an acceleration-based mass estimator, entered via a user interface and/or received by means of a communication interface.

The connection can be dependent on a current and/or predicted climate (across countries) over a planned route of the utility vehicle 10. Here, for example, an energy consumption of the cab heater and/or of the consumer 20 can be taken into account or predicted, for example depending on an outside temperature along the planned route.

In contrast to passenger cars, utility vehicles are operated continuously and in a manner that can be planned. This benefits the operation of the fuel cell device 12. The critical operating ranges for a fuel cell constituted by start-stop and short-term operation periods can be reduced as far as possible in order to increase the service life of the fuel cell device 12.

Preferably, the fuel cell device 12 is embodied as a pre-assembled module that can be tested independently. The module can, for example, have a cooling fluid interface, an electrical interface (for example high-voltage connection) and/or a control interface. The module can be tested for functionality outside the utility vehicle 10 via the interfaces before it is mounted on the utility vehicle 10. The installation on the utility vehicle 10 can be carried out quickly and easily due to the modular design. In addition to the mounting, only the interfaces also have to be connected to the corresponding lines on the utility vehicle. The module can also have a fuel tank, for example.

It is also possible that the fuel cell device 12 is designed as a reversible fuel cell device for producing hydrogen during recuperation when braking the utility vehicle 10, preferably during a connectable continuous braking mode of the utility vehicle 10. For example, a continuous braking mode of the utility vehicle 10 can be activated manually or automatically when the utility vehicle 10 is travelling down an incline, for example a long incline. The reversible fuel cell device is designed to generate hydrogen from excess electricity (electrolysis). Since very high braking power is required when the utility vehicle is braked, for example when driving downhill, the fuel cell device 12 can be used to recuperate the excess electrical energy in the form of hydrogen. This means that cooled braking resistors can be spared, for example.

FIG. 2 shows an exemplary integration of the fuel cell device 12 in a utility vehicle 10.

Preferably, the fuel cell device 12 can be arranged below the cab 26. The fuel cell device 12 can be protected between two longitudinal members of the ladder frame 24.

The fuel cell device 12 can comprise a fuel cell stack 12A and a fuel tank 12B. The fuel tank 12B has a filler neck 32, via which the fuel tank 12B can be filled externally with fuel. The fuel tank 12B can be arranged within the ladder frame 24 behind the fuel cell stack 12A with respect to the forward direction of travel of the utility vehicle 10.

The fuel tank 12B can be a pressure tank, for example for storing for example 5-10 kg hydrogen at 350 bar or more (for example up to 700 bar). The fuel cell stack 12A can have an output of approximately 60 kW, for example.

The fuel tank 12B can be connected to the fuel cell stack 12A via at least one line. If the fuel cell device 12 is configured as a reversible fuel cell device 12, a compressor (not shown) can additionally be included. The compressor can compress the hydrogen generated by the fuel cell device 12 and direct it to the fuel tank 12B.

Cooling of the fuel cell device 12 can be connected to a cooling/heating circuit 34, which can comprise a radiator 36. The radiator 36 can be arranged at the front of the utility vehicle 10 for cooling by means of airflow. The cooling circuit 34 and/or the radiator 36 can preferably be transferred from a conventional truck with internal combustion engine without significant modifications (so-called “carry-over parts”).

The utility vehicle 10 can have plurality of traction batteries 16, for example in the form of high-voltage batteries, each with its own battery management system. The traction batteries 16 can be arranged, for example, on the outer sides of the ladder frame 24 and/or between the longitudinal members of the ladder frame 24. The traction batteries 16 can, for example, each have a capacity of 100 kWh. The traction batteries 16 can be lithium-ion batteries, for example.

Preferably, the fuel cell device 12 (with or without fuel tank 12B) has substantially the same dimensions and/or connection points as each of the plurality of traction batteries 16. The fuel cell device 12 and the plurality of traction batteries 16 can thus be arranged interchangeably.

Depending on the customer's requirements, a different number of traction batteries 16 and fuel cell devices 12 can thus be installed. By adjusting the number of traction batteries 16 and fuel cell devices 12 to the particular intended use of the utility vehicle 10, the lowest possible vehicle weight can be achieved, which is not increased by unnecessary traction batteries, etc. Due to the interchangeability, a number and operating configuration of the fuel cell device or devices 12 can also be freely selected by the customer. If, for example, a subsequent adaptation by a body manufacturer is desired, which requires energy (for example cooling body), this can be taken into account in the vehicle design to obtain the desired vehicle range. Spaces can also be left free, for example right frame side of ladder frame 24 free for milk collector. The ratio of hydrogen storage devices (fuel tank 12B) to electrical storage devices (traction battery 16) can be optimally adjusted depending on the application.

The utility vehicle 10 can further comprise an electrical charging connection 38 for externally charging the traction batteries 16, a high voltage distributor 40, an inverter 42, and an electrical drivetrain 44. As illustrated, the electrical drivetrain 44 can comprise, for example, a central electric drive unit, a gearbox, an articulated shaft, etc. It is also possible that a plurality of electric drive units are present, for example as wheel hub motors or as motors close to the wheels. Incidentally, it is also possible that the fuel cell device 12 is used in a utility vehicle with internal combustion engine, for example as a range extender, to supply the consumer 20 and/or the auxiliary units 18.

In the following, some calculation examples illustrate the applicability of the system described above.

The energy density of a lithium-ion battery can be 1-2 kWh/kg. Compressed gaseous hydrogen (approximately 350 bar), on the other hand, has an energy density of −30 kWh/kg. Consequently, 7-8 kg of hydrogen or approximately 200 l of hydrogen are sufficient to carry twice the energy of a lithium-ion battery with 100 kWh.

By electrochemically converting the energy of the hydrogen in the fuel cell device 12, the traction batteries 16 can be charged while driving. This significantly increases the range of the utility vehicle 10. A utility vehicle requires approximately 100-130 kWh per 100 km. Accordingly, a lithium-ion battery with 100 kWh energy content (until the next charge in 4 h) realistically enables a range of about 80 km. With a fuel cell with 60 kW power, 240 kWh can be converted over a period of 4 h. The range is thus increased by at least 200 km.

With a maximum electrical charging power of 200 kW, the traction batteries 16 can be externally charged with 200 kWh within 1 h. To ‘refuel’ the same amount of energy with hydrogen, only 6-7 kg of compressed hydrogen are required. This is done in a few minutes (<5 min). This means that the driver is never forced to wait for a longer period of time.

The waste heat from the fuel cell device 12 can be used at cold outside temperatures (for example even when the vehicle is at a standstill) in order to heat the battery circuit and the cab circuit. (P_therm=15-20 kW or η_td=83%) This means that, for example, the high-voltage heaters can be spared, thus saving energy, installation space, and costs. The fact that the cooling circuit of the fuel cell can be combined with the high-voltage cooling circuit means that the complexity can be reduced compared to a vehicle powered purely by electric battery. At warm temperatures, the cooling capacity (for example by means of a chiller or intercooler) of the compressed hydrogen can be used to lower the temperature in the cooling circuit.

A lithium-ion battery with an energy content of 100 kWh weighs approximately 640 kg. Consequently, each kg of the battery results in less than 1 kWh of capacity. The fuel cell stack 12A weighs approximately 250 kg. The fuel tank 12B weighs approximately 150 kg. Consequently, the assembly weight can be reduced by up to 250 kg compared to a utility vehicle powered purely by electric battery, although the range is increased.

It is possible that the utility vehicle 10 has a trailer 46 with a consumer 20, as shown in FIG. 3. The interface 28, 30 would therefore be a trailer interface. All of the features described herein with respect to the body 22 with the consumer 20 can also be implemented in the utility vehicle 10 with the trailer 46 and the consumer 20. The trailer 46 can, for example, be a semi-trailer, as shown in FIG. 3. The trailer 46 can also be a trailer of a trailer truck, for example.

It is also possible that the consumer 20 comprises an electrical energy storage device. By means of the electrical energy storage device, for example, an electrically drivable axle of the trailer 46 can be supplied with electrical energy, for example when the trailer 46 is uncoupled from a tractor of the utility vehicle 10. By means of the electrical energy storage device, other electrically driven machines of the trailer 46 (or of the body 22) can alternatively or additionally be supplied with electrical energy, preferably also when the trailer 46 or body 22 is uncoupled from the utility vehicle 10. The electrical energy storage device can be temperature-controlled by a heat exchanger, which is supplied with waste heat from the fuel cell device 12, for example. The electrical energy storage device can also be externally charged by means of the electrical charging connection 38. The electrical energy storage device can also be charged by recuperation of the electrically drivable axle of the trailer 46.

The present disclosure is not limited to the preferred exemplary embodiments described above. Rather, a large number of variants and variations are possible, which also make use of the inventive concept and therefore fall within the scope of protection. In particular, the present disclosure also claims protection for the subject matter and the features of the dependent claims, independently of back-references in the claims. In particular, the individual features of independent claim 1 are each disclosed independently of one another. In addition, the features of the dependent claims are also disclosed independently of all the features of independent claim 1 and, for example, independently of the features relating to the presence and/or configuration of the body or trailer and/or the fuel cell device of independent claim 1. All range indications herein are to be understood as disclosed in such a way that all values falling within the range in question are disclosed individually so to speak, for example also each as preferred narrower outer limits of the range in question.

### LIST OF REFERENCE SIGNS

10 utility vehicle
12 fuel cell device
12A fuel cell stack
12B fuel tank
14 control unit
16 traction battery
18 auxiliary unit
20 consumer
22 body
24 ladder frame
26 cab
28, 30 body/trailer interface
32 tank nozzle
34 cooling/heating circuit
36 radiator
38 charging connection
40 high-voltage distributor
42 inverter
44 electric drivetrain
46 trailer

1-17. (canceled)

18. A utility vehicle comprising:
a body or a trailer with a consumer; and
a fuel cell device, which is designed:
to be connectable as a range extender of the utility vehicle; and
to supply the consumer with electrical energy and/or waste heat.

19. The utility vehicle according to claim 18, wherein:
the utility vehicle is a truck; and/or
the fuel cell device is designed to be operated when the utility vehicle is parked.

20. The utility vehicle according to claim 18, wherein the fuel cell device is designed:
to charge a traction battery of the utility vehicle with electrical energy and/or to control the temperature of the traction battery with waste heat; and/or
to supply a cab heater of the utility vehicle with waste heat and/or electrical energy; and/or
to supply at least one auxiliary unit of the utility vehicle with waste heat and/or electrical energy.

21. The utility vehicle according to claim 20, wherein the fuel cell device, when the utility vehicle is parked, is designed:
to control the temperature of the traction battery with waste heat, to supply the cab heater with waste heat, to supply the consumer with waste heat and/or to supply the auxiliary unit with waste heat; and, at the same time
to charge the traction battery with electrical energy, to supply the consumer with electrical energy, to supply the cab heater with electrical energy and/or to supply the auxiliary unit with electrical energy.

22. The utility vehicle according to claim 20, wherein the fuel cell device, while the utility vehicle is being driven, is designed:
to control the temperature of the traction battery with waste heat, to supply the cab heater with waste heat, to supply the consumer with waste heat and/or to supply the auxiliary unit with waste heat; and, at the same time
to charge the traction battery with electrical energy, to supply the consumer with electrical energy, to supply the cab heater with electrical energy and/or to supply the auxiliary unit with electrical energy.

23. The utility vehicle according to claim 18, further comprising:
a control unit which is designed to control an activation, a deactivation and/or an operation of the fuel cell device, based on:
a planned route of the utility vehicle; and/or
a planned driving time, rest time and/or break time of a driver of the utility vehicle; and/or
a current and/or planned loading of the utility vehicle; and/or
a current and/or predicted climate of the utility vehicle.

24. The utility vehicle according to claim 18, wherein:
a control unit which is designed to automatically control an activation, a deactivation and/or an operation of the fuel cell device, based on:
a planned route of the utility vehicle; and/or
a planned driving time, rest time and/or break time of a driver of the utility vehicle, wherein the planned driving time, rest time, and/or break time are provided by a tachograph; and/or
a current and/or planned loading of the body or trailer; and/or
a current and/or predicted climate over a planned route of the utility vehicle.

25. The utility vehicle according to claim 18, further comprising:
body/trailer interface which can be supplied with electrical energy and/or waste heat from the fuel cell device and to which the consumer is connected.

26. The utility vehicle according to claim 25, wherein:
the body/trailer interface is a standardized interface to which a variety of different bodies or trailers for the utility vehicle can be connected; and/or
the consumer is detachably connected to the body/trailer interface; and/or
the body/trailer interface is arranged in a region of a cab of the utility vehicle; and/or
the body/trailer interface comprises an electrical interface for supplying electrical energy to the consumer; and/or
the body/trailer interface comprises a fluid interface for supplying waste heat to the consumer, wherein the fluid interface is fluidically connected and/or thermally coupled to a cooling system of the fuel cell device.

27. The utility vehicle according to claim 25, wherein:
the body/trailer interface is a standardized interface to which a variety of different bodies or trailers for the utility vehicle can be detachably connected; and/or
the consumer is plugged in and/or screwed onto the body/trailer interface; and/or
the body/trailer interface is arranged in a rear region of a cab of the utility vehicle.

28. The utility vehicle according to claim 18, further comprising:
a ladder frame, wherein the fuel cell device is arranged within the ladder frame.

29. The utility vehicle according to claim 28, wherein:
the fuel cell device is arranged directly below a cab of the utility vehicle.

30. The utility vehicle according to claim 28, wherein:
the fuel cell device has a fuel cell stack and a fuel tank, wherein the fuel tank is arranged inside the ladder frame and/or behind the fuel cell stack with respect to a forward direction of travel of the utility vehicle.

31. The utility vehicle according to claim 18, further comprising:
a plurality of traction batteries,
wherein the fuel cell device has substantially the same dimensions and/or connection points as each of the plurality of traction batteries, so that the fuel cell device and the plurality of traction batteries can be arranged interchangeably.

32. The utility vehicle according to claim 18, wherein:
the fuel cell device is embodied as a pre-assembled and/or independently testable module, which has a cooling fluid interface, an electrical interface and/or a control interface.

33. The utility vehicle according to claim 18, wherein:
the fuel cell device is embodied as a reversible fuel cell device for producing hydrogen during recuperation when braking the utility vehicle.

34. The utility vehicle according to claim 18, wherein:
the fuel cell device is embodied as a reversible fuel cell device for producing hydrogen during a connectable continuous braking mode of the utility vehicle.

35. The utility vehicle according to claim 18, wherein:
the fuel cell device comprises a polymer electrolyte fuel cell, a direct methanol fuel cell and/or a reforming methanol fuel cell.

36. The utility vehicle according to claim 18, wherein:
the body is supported on a frame of the utility vehicle and/or is arranged behind a cab of the utility vehicle; and/or
the body is a tank body, an emergency vehicle body, a cleaning body, a loading body, a cooling body or a heating body; and/or
the trailer comprises a tank, a loading area, a loading space, a cooling unit, a heating unit and/or a pump; and/or
the trailer is a semi-trailer; and/or
the utility vehicle is a trailer truck or an articulated truck; and/or
the consumer comprises an electrically driven machine and/or a heat exchanger.

37. The utility vehicle according to claim 18, wherein:
the consumer comprises an electrical energy storage device.

38. The utility vehicle according to claim 37, wherein:
the trailer has an electrically drivable axle that is operable with electrical energy from the electrical energy storage device of the consumer, and/or charges the electrical energy storage device by recuperation during driving operation; and/or
the consumer further comprises a heat exchanger for controlling the temperature of the electrical energy storage device; and/or
the consumer further comprises an electrically driven machine, which is operable with electrical energy from the electrical energy storage device of the consumer; and/or
the electrical energy storage device can be charged externally by means of an electrical charging connection.

39. The utility vehicle according to claim 37, wherein:
the trailer has an electrically drivable axle that is operable with electrical energy from the electrical energy storage device of the consumer when the trailer is uncoupled from a tractor of the utility vehicle; and/or
the consumer further comprises an electrically driven machine, which is operable with electrical energy from the electrical energy storage device of the consumer in the uncoupled state of the trailer or body from the utility vehicle; and/or
the electrical energy storage device can be charged externally by means of an electrical charging connection, wherein the electrical charging connection is arranged on the utility vehicle separately from the trailer or body.
